(19) United States
(12) Patent Application Publication
(10) Pub. No.: US 2026/0342518 A1
(43) Pub. Date: Oct. 29, 2026

(54) TRACKING REFERENCE SIGNAL REQUEST

(71) Applicant: Nokia Technologies Oy, Espoo (FI)

(72) Inventors: Timo KOSKELA, Oulu (FI); Sanjay GOYAL, Denville, NJ (US); Mihai ENESCU, Espoo (FI); Juha Pekka KARJALAINEN, Sotkamo (FI); Sami-Jukka HAKOLA, Oulu (FI)

(21) Appl. No.: 19/191,831

(22) Filed: Apr. 28, 2025

(51) Int. Cl. H04L 5/00; H04L 1/00; H04L 1/1812; H04W 74/0816

(52) U.S. Cl. CPC H04L 5/0051; H04L 1/0003; H04L 1/1812; H04L 5/0044; H04W 74/0816

(57) ABSTRACT

Example embodiments of the present disclosure are directed to tracking reference signal (TRS) request. In a method, an apparatus determines whether at least one condition is satisfied. The at least one condition at least includes a first condition that a block error rate of a transmission via a physical shared channel is higher than a threshold value. If the at least one condition is satisfied, the apparatus transmits an indication of a request for at least one TRS to a further apparatus.

### FIELD

Various example embodiments of the present disclosure generally relate to the field of telecommunication and in particular, to methods, devices, apparatuses and computer readable storage medium for tracking reference signal (TRS) request.

### BACKGROUND

A communication network may serve as a facility that enables communication between two or more communication devices or provides communication devices access to a data network. A mobile or wireless communication network is one example of a communication network. A communication device may be provided with a service by an application server.

In some communication systems such as the next cellular systems, user equipment (UE) may perform a channel estimation by measuring a reference signal (RS) from the network. For example, the reference signal may be a channel state information (CSI)-RS. The CSI-RS may be UE-specifically configured via radio resource control (RRC) signaling. It is proposed that a TRS, which may be a variant of CSI-RS or a separate RS, may be used for assisting UE in channel estimation.

### SUMMARY

In a first aspect of the present disclosure, there is provided an apparatus. The apparatus comprises at least one processor; and at least one memory storing instructions that, when executed by the at least one processor, cause the apparatus to: determine whether at least one condition is satisfied, the at least one condition at least comprising a first condition that a block error rate of a transmission via a physical shared channel is higher than a threshold value; and in accordance with a determination that the at least one condition is satisfied, transmit an indication of a request for at least one TRS to a further apparatus.

In a second aspect of the present disclosure, there is provided a method. The method comprises: determining, at an apparatus, whether at least one condition is satisfied, the at least one condition at least comprising a first condition that a block error rate of a transmission via a physical shared channel is higher than a threshold value; and in accordance with a determination that the at least one condition is satisfied, transmitting an indication of a request for at least one TRS to a further apparatus.

In a third aspect of the present disclosure, there is provided an apparatus. The apparatus comprises means for determining whether at least one condition is satisfied, the at least one condition at least comprising a first condition that a block error rate of a transmission via a physical shared channel is higher than a threshold value; and means for in accordance with a determination that the at least one condition is satisfied, transmitting an indication of a request for at least one TRS to a further apparatus.

In a fourth aspect of the present disclosure, there is provided a computer readable medium. The computer readable medium comprises instructions stored thereon for causing an apparatus to perform at least the method according to the second aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates an example diagram for TRS configuration options in accordance with some example embodiments of the present disclosure;

FIG. 3 illustrates an example signaling flow for TRS request in accordance with some example embodiments of the present disclosure;

FIG. 4 illustrates another example signaling flow for TRS request in accordance with some example embodiments of the present disclosure;

FIG. 5 illustrates another example signaling flow for TRS request in accordance with some example embodiments of the present disclosure;

FIG. 6 illustrates another example signaling flow for TRS request in accordance with some example embodiments of the present disclosure;

FIG. 7 illustrates a flowchart of a method implemented at a first apparatus in accordance with some example embodiments of the present disclosure;

FIG. 8 illustrates a flowchart of a method implemented at a second apparatus in accordance with some example embodiments of the present disclosure;

FIG. 9 illustrates a flowchart of a method implemented at a first apparatus in accordance with some example embodiments of the present disclosure;

FIG. 10 illustrates a flowchart of a method implemented at a second apparatus in accordance with some example embodiments of the present disclosure;

FIG. 11 illustrates a flowchart of a method implemented at a first apparatus in accordance with some example embodiments of the present disclosure;

FIG. 12 illustrates a flowchart of a method implemented at a second apparatus in accordance with some example embodiments of the present disclosure;

FIG. 13 illustrates a flowchart of a method implemented at a third apparatus in accordance with some example embodiments of the present disclosure;

FIG. 14 illustrates a flowchart of a method implemented at a first apparatus in accordance with some example embodiments of the present disclosure;

FIG. 15 illustrates a simplified block diagram of a device that is suitable for implementing example embodiments of the present disclosure; and

FIG. 16 illustrates a block diagram of an example computer readable medium in accordance with some example embodiments of the present disclosure.

Throughout the drawings, the same or similar reference numerals represent the same or similar element.

### DETAILED DESCRIPTION

Principles of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second,” . . . , etc. in front of noun(s) and the like may be used herein to describe various elements, these elements should not be limited by these terms. These terms are only used to distinguish one element from another and they do not limit the order of the noun(s). For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a user device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), 5G-advanced, the sixth generation (6G) communication protocols, wireless local network communication protocols such as Institute for Electrical and Electronics Engineers (IEEE) 802.11 and the like, and/or any other protocols either currently known or to be developed in the future. Embodiments of the present disclosure may be applied in various communication systems. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a user device accesses the network and receives services therefrom. The network device may refer to a base station (BS) or an access point (AP), for example, a node B (NodeB or NB), an evolved NodeB (eNodeB or eNB), a next generation NB (also referred to as a gNB), a remote radio unit (RRU), a radio head (RH), a remote radio head (RRH), a relay, an integrated access and backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a centralized unit (CU) and a distributed unit (DU). The CU may control a plurality of DUs acting at least as transmit/receive (Tx/Rx) nodes. In some embodiments, the DUs may comprise e.g., a radio link control (RLC) layer, a medium access control (MAC) layer and a physical (PHY) layer, whereas the CU may comprise the layers above RLC layer, such as a packet data convergence protocol (PDCP) layer, a radio resource control (RRC) and an internet protocol (IP) layer. An IAB node comprises a mobile terminal (IAB-MT) part that behaves like a UE toward the parent node, and a DU part of an IAB node behaves like a base station toward the next-hop IAB node.

The term “user device” or “terminal device” refers to any end device that may be capable of wireless communication. By way of example rather than limitation, a user device may also be referred to as UE, a subscriber station (SS), a portable subscriber station, a mobile station (MS), or an access terminal (AT). The user device may include, but not limited to, a mobile phone, a cellular phone, a smart phone, voice over IP (VoIP) phones, wireless local loop phones, a tablet, a wearable user device, a personal digital assistant (PDA), portable computers, desktop computer, image capture user devices such as digital cameras, gaming user devices, music storage and playback appliances, vehicle-mounted wireless user devices, wireless endpoints, mobile stations, laptop-embedded equipment (LEE), laptop-mounted equipment (LME), universal serial bus (USB) dongles, smart devices, wireless customer-premises equipment (CPE), an internet of things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The user device may also correspond to a mobile termination (MT) part of an IAB node (e.g., a relay node). In the following description, the terms “user device”, “terminal device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a user device and a network device, such as a resource in time domain, a resource in frequency domain, a resource in space domain, a resource in code domain, or any other combination of the time, frequency, space and/or code domain resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

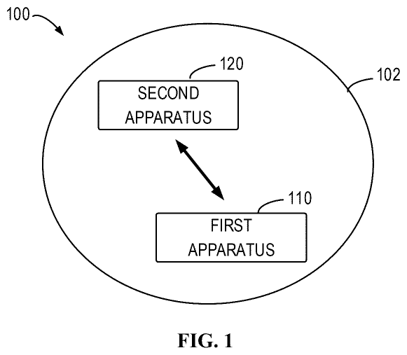

FIG. 1 illustrates an example communication environment 100 in which example embodiments of the present disclosure can be implemented. As shown in FIG. 1, the communication environment 100 may include a first apparatus 110, which may operate as a terminal device such as UE. The communication environment 100 may further include a second apparatus 120, which may operate as a BS or a gNB serving the UE. The serving area of the second apparatus 120 may be called a cell 102.

In some example embodiments, the second apparatus 120 may be coupled with or equipped with one or more transmission and reception points (TRPs). The second apparatus 120 may transmit at least one RS to the first apparatus 110 via the one or more TRPs. The at least one RS may include CSI-RS, TRS, demodulation RS, and/or the like.

In some example embodiments, a communication direction from the second apparatus 120 to the first apparatus 110 may be referred to as a downlink (DL), and a communication direction from the first apparatus 110 to the second apparatus 120 may be referred to as an uplink (UL). In DL, the second apparatus 120 may be a transmitting (TX) device (or a transmitter) and the first apparatus 110 may be a receiving (RX) device (or a receiver). In UL, the first apparatus 110 may be a TX device (or a transmitter) and the second apparatus 120 may be an RX device (or a receiver).

It is to be understood that the number or type of apparatuses and their connections shown in FIG. 1 are only for the purpose of illustration without suggesting any limitation. The communication environment 100 may include any suitable number or type of apparatuses or devices configured to implement some example embodiments.

In communication systems, a TRS, which may be a variant of CSI-RS or a separate RS, may be used to assist the UE in performing channel estimation for the purpose of receiving downlink signals and channels such as the physical downlink control channel (PDCCH) and physical downlink shared channel (PDSCH). Based on the TRS, the UE may perform time and frequency synchronization tracking, as well as estimation of long-term doppler shift, doppler spread, delay spread, and average delay. In some communication systems, a periodic TRS may be configured for each UE. The periodic TRS may be transmitted using a cell-specific synchronization signal and/or physical broadcast channel (SS/PBCH, SSB) beam.

The TRS may be configured as one-port CSI-RS resource(s) with several parameters, including but not limited to a TRS burst length, TRS burst periodicity, and/or the like. The TRS burst length may include two consecutive valid downlink slots in frequency range 1 (FR1), and either one or two consecutive valid downlink slots in frequency range 2 (FR2). Within each TRS slot, there may be two TRS symbols. These TRS symbols may be arranged such that there may be a separation of three symbols between them in the slot. The periodicity of the TRS burst may be configured as any suitable number such as 10 ms, 20 ms, 40 ms, 80 ms, and/or the like.

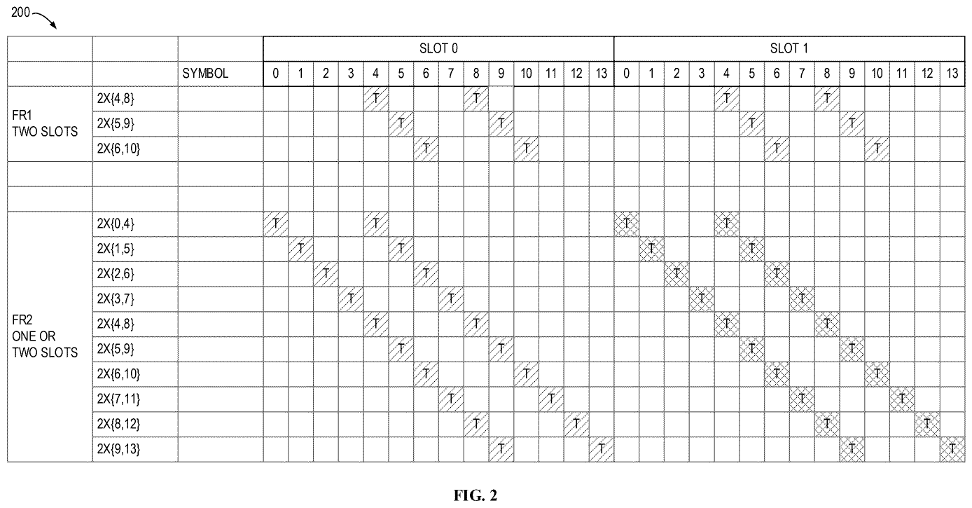

FIG. 2 illustrates an example 200 for different TRS configuration options within the TRS slots, providing an understanding of the TRS configuration options in terms of symbol positions within downlink slots for both the FR1 and the FR2. As illustrated, for the FR1, the TRS may be configured over two consecutive slots (i.e., slot 0 and slot 1). Each TRS slot includes two TRS symbols that are separated by several symbols, such as symbols #4 and #8, or symbols #5 and #9, and the like.

For the FR2, the TRS may be configured over either one or two consecutive downlink slots. For example, the slot 0 may include two TRS symbols that are separated by several symbols, such as symbols #0 and #4, or symbols #1 and #5, and the like. Alternatively, or in addition, the slot 1 may include two TRS symbols that are separated by several symbols, such as symbols #0 and #4, or symbols #1 and #5, and the like. FIG. 2 presents multiple example TRS symbol combinations and for example the two TRS symbols may be inserted per slot with a fixed separation of several symbols.

In communication systems such as 5G communication system, the TRS may be periodic and UE-specific. That is, the TRS may be configured separately for each UE. There may also be an additional aperiodic TRS, but the aperiodic TRS may be associated with the periodic TRS and shares the same QCL source as the periodic TRS, such as for example, a synchronization signal and PBCH block (SSB) in communication systems, which may include primary and secondary synchronization signals, and PBCH and DMRS for PBCH demodulation.

A UE configured with non-zero power (NZP)-CSI-RS-ResourceSet(s) configured with higher layer parameter trs-Info may have the CSI-RS resources configured as: (1) periodic, with the CSI-RS resources in the NZP-CSI-RS-ResourceSet configured with same periodicity, bandwidth and subcarrier location; and/or (2) periodic CSI-RS resource in one set and aperiodic CSI-RS resources in a second set, with the aperiodic CSI-RS and periodic CSI-RS resource having the same bandwidth (with same RB location) and the aperiodic CSI-RS being configured with qcl-Type set to ‘typeA’ and ‘typeD’, where applicable, with the periodic CSI-RS resources.

A common TRS may be detected and used by UEs in IDLE or INACTIVE mode for the purpose of updating channel estimation filter parameters such as an average delay, a delay spread, a doppler shift, and a doppler spread.

Several QCL relations are supported, including but not limited to: ‘QCL-typeA’: {Doppler shift, Doppler spread, average delay, delay spread}, ‘QCL-TypeB’: {Doppler shift, Doppler spread}, ‘QCL-typeC’: {Doppler shift, average delay}, ‘QCL-typeD’: {Spatial Rx parameter}. The QCL relations may extend from the SSB and P-TRS to the DMRS of PDCCH, DMRS of PDSCH, and CSI-RS for CSI, using QCL-typeA and QCL-typeD, and from SSB using QCL-typeC and QCL-typeD.

In communication systems such as 5G systems, the TRS may be configured and triggered by a network. The TRS may be either periodic only or both periodic and aperiodic and the aperiodic TRS may be associated with the periodic TRS.

In some communication systems, one use case of the TRS may be to enable the UE to perform tracking of radio channel characteristics in both time and frequency domains. By doing so, the UE may compensate for variations in these characteristics, which in turn may support higher peak data rates. The TRS may facilitate the use of higher order modulation schemes, including those beyond 16 quadrature amplitude modulation (QAM). The UE may expect a configuration of the periodic TRS, as it serves as the QCL source.

The aperiodic TRS (aTRS) may be associated with the periodic TRS, meaning that aperiodic TRS may not be transmitted independently of the periodic TRS. A requirement of more energy efficiency of communication systems may drive system designs toward relying solely on the aperiodic TRS, or on TRS that may not be persistently present. In other words, most optimal design would be to transmit TRS only when needed but the network may not have complete view on the UE channel conditions. In some scenarios, the UE may be able to perform tracking based certain reference signal which may be periodic but may only be able to provide limited (although may be sufficient for certain scenarios) tracking performance for cases with high MCS index or peak rate scenarios, or for cases where channel conditions or UE reception assumptions change relatively quickly, or for cases that the UE enters connected mode or another cell.

In accordance with some example embodiments of the present disclosure, there are provided solutions for TRS request. In a solution, a first apparatus such as UE determines whether at least one condition for requesting a TRS is satisfied based on a configuration from a second apparatus such as gNB, data to be transmitted to the second apparatus, a BSR, an MCS associated with the first apparatus, a rank associated with the first apparatus, and/or the like. If the at least one condition is satisfied, the first apparatus transmits, to the second apparatus, indication information indicative of a request for at least one TRS from the second apparatus. In this way, the first apparatus can request the TRS from the second apparatus when the first apparatus needs a new or additional TRS.

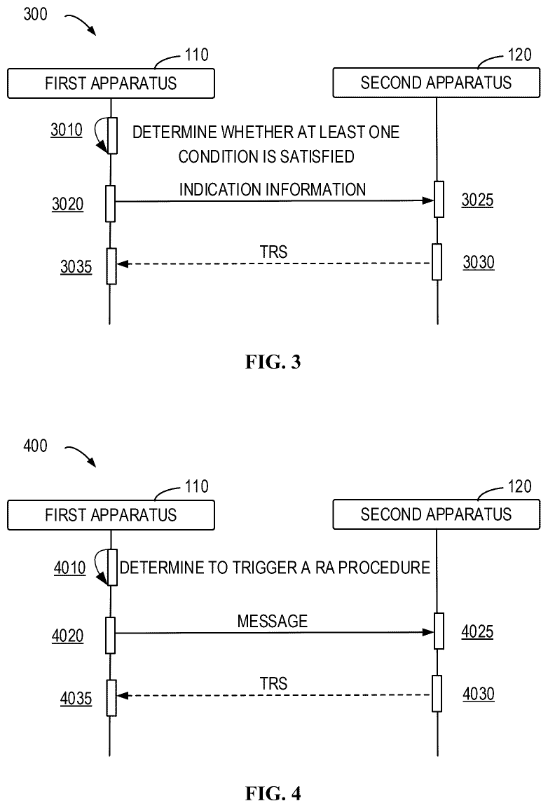

FIG. 3 illustrates an example signaling flow 300 for TRS request in accordance with some example embodiments of the present disclosure. The signaling flow 300 involves the first apparatus 110 and the second apparatus 120 in FIG. 1. It is assumed that the first apparatus 110 is in a connected mode such as RRC connected mode with the second apparatus 120.

In operation, the first apparatus 110 determines (3010) whether at least one condition for requesting a TRS is satisfied based on a configuration from a second apparatus such as gNB, data to be transmitted to the second apparatus, a BSR, an MCS associated with the first apparatus 110, a rank associated with the first apparatus 110, and/or the like. If the at least one condition is satisfied, the first apparatus 110 transmits (3020), to the second apparatus 120, indication information indicative of a request for at least one TRS from the second apparatus. Correspondingly, the second apparatus 120 receives (3025) the indication information. As used herein, requesting a TRS may also be referred to as requesting a TRS transmission. In this manner, the first apparatus can request the TRS from the second apparatus when the first apparatus needs a new TRS.

By way of example, the indication information may be comprised in uplink control information (UCI), medium access control control element (MAC CE,) RRC message, a bitfield or an indication in a CSI report, a further uplink signal, and/or the like. The further uplink signal may be associated with a random access procedure or a cell switch procedure. The further uplink signal may be a random access preamble, a scheduling request, a UCI format, or the like. The requested TRS may be an aperiodic TRS, semi-persistent TRS, and/or the like. For the purpose of discussion, some example embodiments will be described with respect to the aperiodic TRS. It is to be understood that these example embodiments described with respect to the aperiodic TRS may also be applied to the semi-persistent TRS, or the like.

In response to receiving (3025) the indication information, the second apparatus 120 transmits (3030) the at least one TRS to the first apparatus 110. Correspondingly, the first apparatus 110 receives (3035) the at least one TRS. In this manner, the first apparatus 110 may obtain the TRS when needed.

In an example, the at least one condition may include that the data to be transmitted to the second apparatus 120 arrives, for example, UL data arrives. For example, the first apparatus 110 may be configured to (or allowed) to request TRS when it determines that it has UL data arrival event. The TRS request in such a situation may be requesting a TRS transmission as part of data transmission or reception procedure.

In another example, the at least one condition may include that the first apparatus 110 triggers a scheduling request of a BSR transmission. The first apparatus 110 may determine to request TRS when the first apparatus 110 triggers scheduling request for BSR transmission.

In a further example, the at least one condition may include that no TRS being received within a time window for a previously requested TRS. That is, the first apparatus 110 may retransmit the request for TRS.

In a further example, the at least one condition may include that the first apparatus 110 supports the rank associated with the first apparatus 110 based on channel measurement. As used herein, the rank associated with the first apparatus 110 may be a rank currently used by the first apparatus 110, a rank indicated by the second apparatus 120 to the first apparatus 110, a rank being reported by the first apparatus 110, and/or the like. In one example, the first apparatus 110 may provide the indication information of the TRS request when it determines that it is capable to support certain rank based on the measurement e.g. (multiple) SSB or CSI-RS measurements.

In a further example, the at least one condition may include that the first apparatus 110 is unable to support at least one of the MCS or the rank associated with the first apparatus 110 without receiving a TRS. As used herein, the MCS associated with the first apparatus 110 may be an MCS currently used by the first apparatus 110, an MCS indicated by the second apparatus 120 to the first apparatus 110, an MCS being reported by the first apparatus 110, and/or the like. In one example embodiment, as a trigger condition for event triggered TRS request, the first apparatus 110 may determine that currently indicated (or last indicated or previously) MCS or rank may not be supported by the first apparatus 110 without TRS reception.

In a further example, the at least one condition may include that the first apparatus 110 is unable to support at least one of the MCS or the rank with a current TRS with at least one parameter of the TRS. As used herein, the at least one parameter of the TRS may include, but not limited to, a length of the at least one TRS, frequency allocation information for the at least one TRS, a periodicity of the at least one TRS, and/or the like. The length of the at least one TRS may be the number of slots of the TRS, the number of symbols, milliseconds, or the like. The frequency allocation information may include bandwidth (BW) of the TRS. In one example embodiment, as a trigger condition for event triggered TRS request, the first apparatus 110 may determine that currently indicated MCS or rank (by the network or reported by the first apparatus 110) may not be supported by the first apparatus with TRS with current periodicity or BW or number of slots of the TRS.

Several example conditions for requesting the TRS have been described. It is to be understood that these conditions are only described for the purpose of illustration, without suggesting any limitation. Any suitable condition may be applied. These conditions may be used separately, or in any combination. Scope of the present disclosure is not limited in this regard. Further conditions will be described with respect to FIG. 6.

In some example embodiments, the second apparatus 120 may transmit, to the first apparatus 110, configuration information including at least one condition for requesting the at least one TRS transmission, an indicated MCS, an indicated rank, and/or the like. That is, the at least one condition for requesting the TRS and optionally the MCS or rank used for the at least one condition may be configured by the network. Alternatively, the at least one condition or part of the at least one condition such as the MCS or rank may be predefined, or may be determined by the first apparatus 110.

In one example, the TRS request may be a UE event triggered report or indication. An event type is defined and configured for the first apparatus 110 wherein the event criteria is based on current MCS or rank or the most recently reported MCS or rank. The second apparatus 120 such as the network may configure the first apparatus 110 a certain MCS or rank threshold associated with a TRS request.

In some example embodiments, the indication information may include an indication requesting the second apparatus 120 to provide the at least one TRS prior to or when scheduling downlink data. For example, the TRS request may imply that the first apparatus 110 requests (aperiodic or semi persistent) TRS when it is configured to receive data. For example, the first apparatus 110 may send the request indicating that it expects TRS transmission when the network starts to schedule data.

In some examples, the indication information may include an indication that the at least one TRS is expected with a time interval after transmitting the indication information. The first apparatus 110 may expect the TRS to be transmitted within X slots/milliseconds/symbols after sending the request. In another example, the resource for sending the indication may be periodic (i.e., periodic indication occasion), and if the first apparatus 110 has not received TRS before the next indication occasion, the first apparatus 110 may transmit indication. In another example, the first apparatus 110 may expect the TRS (once indicated) prior to the data scheduling.

In some example embodiments, the indication information may include one or more of: the time interval for the TRS reception, a type of the at least one TRS, a CQI index, an MCS index, a rank value, and/or the like. The type of the at least one TRS may be an aperiodic TRS, or a semi persistent TRS. The at least one of the CQI index, MCS index, or rank value in the indication information may be above a corresponding threshold. The corresponding threshold may be predefined, or configured by the second apparatus 120, or determined and indicated to the second apparatus 120 by the first apparatus 110.

In one example, the indication information of the TRS request may be implicitly indicated by a channel quality indicator (CQI) report indicating certain CQI index or certain MCS value or rank value above threshold value. This threshold value may be indicated by the first apparatus 110. As an example, the first apparatus 110 may expect the TRS transmission by network. In one example the threshold value may be indicated by the first apparatus 110, i.e., that for supporting certain MCS value or rank, a TRS may be requested.

In one example embodiment, the first apparatus 110 may send an indication indicating a threshold value for MCS or rank for which it needs the TRS. The threshold value may be indicated by the first apparatus 110 that for supporting certain MCS or rank value, for which TRS is not requested or required. Alternatively, the threshold value may be indicated by the first apparatus 110 that for supporting certain MCS or rank value, for which TRS is required.

In some example embodiments, the indication information may include at least one parameter (or property) for the at least one TRS, an indication of a configuration of the at least one parameter for the at least one TRS, and/or the like. The at least one parameter of the TRS may include, but not limited to, a length of the at least one TRS, frequency allocation information for the at least one TRS, a periodicity of the at least one TRS, and/or the like. In other words, the first apparatus 110 may request certain TRS properties as part of the TRS request. For example, the TRS request may be for (aperiodic) TRS, and the indication information may indicate whether the TRS is one slot, two slot or N slot (N being a positive integer). The indication information may further include frequency domain allocation such as BW information, periodicity or interval for TRS, and the like. In one example embodiment, the indication information of the TRS request may point to a set of RRC configured TRS configurations (for example, time information such as one slot, two slots, or time interval, frequency domain allocation). The indication information may indicate one of the configurations by indicating a codepoint such as at least one bit value. The TRS request may be for aperiodic or semi-persistent TRS. The indication information may further indicate periodicity for the semi-persistent TRS, number of slots, and BW for the TRS.

In some example embodiments, if no TRS is received with a time window for receiving the at least one TRS, the first apparatus 110 may retransmits the indication information such as the explicit TRS request or implicit indication to the second apparatus 120. Alternatively, or in addition, if no TRS is received with a time window for receiving the at least one TRS, the first apparatus 110 may limit a rank, an MCS, and/or a channel quality indicator to be reported to the second apparatus 120 to a predefined or configured value.

For example, the first apparatus 110 may expect the TRS to be transmitted within a time window of X slots or milliseconds or symbols after sending the request, X being a positive integer. If the first apparatus 110 does not receive the TRS after the time window, the first apparatus 110 may retransmit the request, and/or may limit the reported rank/MCS/CQI to certain value(s).

In some example embodiments, the first apparatus may transmit, to the second apparatus 120, an indication for suspending of a usage of the at least one TRS from the second apparatus 120. The first apparatus 110 may be configured to indicate to the network to stop or suspend the utilization of the TRS. The stop or suspend indication may be triggered due to time-frequency drifts observed by the first apparatus 110 and the indication indicates that TRS does not benefit the tracking performance of the first apparatus 110.

With these example embodiments, the first apparatus 110 such as UE may be configured to indicate to network that it requests TRS transmission by the network. The UE may be configured with UE initiated indication for requesting tracking reference signal based on observed or estimated time or frequency tracking performance in connected mode. By requesting the TRS from the network, the requested TRS may be used for channel estimation enhancement.

In some example embodiments of the present disclosure, a first apparatus such as UE may determine to trigger a random access procedure with a second apparatus such as gNB. The first apparatus then may transmit, to the second apparatus, a message associated with the random access procedure, the message indicating a request for at least one TRS from the second apparatus. In response to receiving the message, the second apparatus may transmit the at least one TRS to the first apparatus 110. In this manner, the first apparatus can transmit an early TRS request for cell access.

FIG. 4 illustrates an example signaling flow 400 for TRS request associated with the random access procedure in accordance with some example embodiments of the present disclosure. The signaling flow 400 involves the first apparatus 110 and the second apparatus 120 in FIG. 1.

In operation, the first apparatus 110 determines (4010) to trigger a random access (RA) procedure with the second apparatus 120. The random access procedure may be a contention based random access (CBRA) or a contention free random access (CFRA). The random access procedure may be the RA procedure where the first apparatus 110 enters to connected mode from IDLE or INACTIVE mode.

The first apparatus 110 transmits (4020), to the second apparatus 120, a message associated with the random access procedure. The message indicates a request for at least one TRS from the second apparatus 120. Correspondingly, the second apparatus 120 receives (4025) the message. In response to receiving (4025) the message, the second apparatus 120 may transmit (4030) the at least one TRS to the first apparatus 110. The first apparatus 110 may receive (4035) the at least one TRS correspondingly. In this way, the first apparatus 110 may be configured to request tracking reference signal based on observed or estimated time or frequency tracking performance when entering a connected mode.

By way of example, the message associated with the random access procedure may include, but not be limited to, a random access preamble such as that carried in Msg1 of a random access procedure, a message multiplexed with Msg3 of the random access procedure, or the Msg3. In one example, the RA preambles (in Msg1) may be associated with early TRS request. That is, transmitting the RA preamble indicates also the first apparatus 110 is requesting TRS transmission by network. In another example, the TRS request may be multiplexed with Msg3 and transmitted on the uplink grant for Msg3 or as part of the Msg3 of the RA procedure.

In some example embodiments, the first apparatus 110 may determine whether at least one channel condition for requesting the at least one TRS is satisfied. The transmitting of the request is in response to the at least one channel condition being satisfied.

The first apparatus 110 may receive, from the second apparatus 120, configuration information including at least one channel condition for indicating the request for the at least one TRS in the message associated with the random access procedure, an MCS threshold value, a CQI threshold value, a rank threshold, and/or the like. In an example, the at least one channel condition may include that a MCS is above or equal to the MCS threshold value. In another example, the at least one channel condition may include that a CQI is above or equal to the CQI threshold value. In a further example, the at least one channel condition may include that a rank is above or equal to the rank threshold. Alternatively, the at least one channel condition may be predefined.

Several example channel conditions for requesting the TRS have been described. It is to be understood that these channel conditions are only described for the purpose of illustration, without suggesting any limitation. Any suitable channel condition may be applied. These channel conditions may be used separately, or in any combination. Scope of the present disclosure is not limited here.

In one example embodiment, the first apparatus 110 may (be configured to) indicate the TRS request if it determines that it has measured the channel conditions for the early CSI to be above or equal to the certain threshold value. In one example, the early CSI may refer to measurements and/or reporting of CSI measurements performed before or during performing access signaling for entering CONNECTED mode (e.g. from IDLE or INACTIVE). The channel condition may refer to MCS condition, CQI condition, rank condition, and/or the like. The first apparatus 110 may determine the at least one channel condition based on at least one measured CSI-RS scheduled by the second apparatus 120 or indicated in system information. That is, the measured reference signals for determining the channel conditions may be CSI-RS scheduled by the network or indicated in the system information.

In some examples, the message associated with the random access procedure may explicitly indicate the request for TRS. For example, the message may indicate an indication requesting the second apparatus 120 to provide the at least one TRS prior to or when scheduling downlink data. In another example, the message may indicate an indication that the at least one TRS is expected with a time interval after transmitting the indication information. The message may further indicate the time interval. The message may a type of the at least one TRS, such as aperiodic TRS or semi-persistent TRS.

In some examples, the message may implicitly indicate the TRS request. For example, the message may include a CQI index, an MCS index (or MCS value), a rank value, or the like, above a threshold value. The message may further indicate at least one parameter for the at least one TRS, and/or an indication of a configuration of the at least one parameter for the at least one TRS. Details of the TRS parameters have been described with respect to FIG. 3, and will not be repeated here.

With these example embodiments, the first apparatus 110 such as UE is configured or defined to send a message related to TRS request to a serving cell as part of the RA procedure. Such early TRS request for cell access may be used to obtain TRS for subsequent channel estimation.

In some example embodiments of the present disclosure, a first apparatus such as UE may receive a cell switch command message indicating a cell switch from a first cell to a second cell associated with a second apparatus. The first apparatus thus performs the cell switch to the second cell. The first apparatus may further transmit, to the second apparatus, information indicating a request for at least one TRS from the second apparatus. In response to receiving the information indicating the request, the second apparatus may transmit the at least one TRS to the first apparatus. In this manner, an early TRS request during cell switch can be achieved.

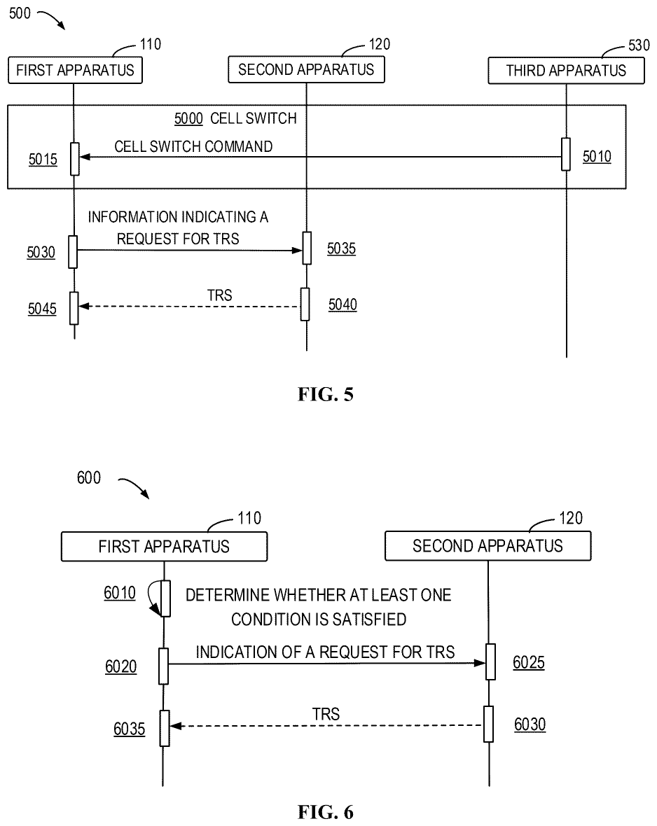

FIG. 5 illustrates an example signaling flow 500 for TRS request in accordance with some example embodiments of the present disclosure. The signaling flow 500 involves the first apparatus 110 and the second apparatus 120 in FIG. 1, and a third apparatus 530. The third apparatus 530 may be another implementation of the second apparatus 120 such as another network device. It is assumed that a current serving cell or source (serving) cell (referred to as a first cell) of the first apparatus 110 is associated with the third apparatus 530, and a new serving cell or target (serving) cell (referred to as a second cell) is associated with the second apparatus 120.

In operation, the second apparatus 120 and the third apparatus 530 may perform the cell switch procedure (5000) for the first apparatus 110. During the cell switch procedure (5000), the third apparatus 530 transmits (5010), to the first apparatus 110, a cell switch command message indicating a cell switch from the first cell associated with the third apparatus to the second cell associated with a second apparatus 120. Correspondingly, the first apparatus 110 receives (5015) the cell switch command message. For example, the cell switch command message may be a handover command, a MAC CE command for cell switch, or the like.

In response to receiving (5010) the cell switch command message, the first apparatus 110 performs the cell switch to the second apparatus 120.

The first apparatus 110 transmits (5030), to the second apparatus 120, information indicating a request for at least one TRS from the second apparatus 120. In response to receiving (5035) the information indicating the request, the second apparatus 120 transmits (5040), to the first apparatus 110, the at least one TRS. Correspondingly, the second apparatus 120 receives (5045) the at least one TRS. The at least one TRS may be aperiodic TRS or semi-persistent TRS.

In some example embodiments, the information indicating the TRS request may be included in UCI, MAC CE, RRC message, and/or the like. By way of example, the information indicating the request may be transmitted via an uplink channel associated with a grant for a random access channel (RACH)-less cell switch. The grant may be a configured grant for the cell switch, or a dynamic grant for the cell switch. In a further example, the TRS request may be sent using an uplink channel associated with a dynamic grant configured for Msg3 in RACH-based cell switch. In a further example, the TRS request may be sent using an uplink channel associated with a dynamic grant configured for an uplink transmission after the completion of the RACH procedure (e.g., message5).

In some example embodiments, the cell switch command message may indicate a requirement of a request for at least one TRS from the second apparatus 120. In one option, the cell switch command may contain an indication related to the TRS request. For example, the cell switch command may indicate a request for the first apparatus 110 to send a TRS request to the target cell. Alternatively, or in addition, in some example embodiments, the cell switch command message may indicate at least one configured parameter for the at least one TRS. For example, the cell switch command may indicate a TRS configuration given in a cell switch configuration. Details of the TRS parameters have been described with respect to FIG. 3, and will not be repeated here.

During the cell switch procedure, the second apparatus 120 may transmit its TRS configurations to the third apparatus 530. That is, the information of TRS configurations associated with a candidate cell may be shared with the source cell. Likewise, the source cell or the third apparatus 530 may send the information of the indicated TRS configuration in the cell switch command to the target cell of the second apparatus 120.

In some example embodiments, the first apparatus 110 may determine whether at least one channel condition for requesting the at least one TRS is satisfied for the second cell based on measurements of the second cell performed before the cell switch. The first apparatus 110 determines based on observed or estimated channel conditions for the target cell, based on the measurements made before the cell switch. The transmitting of the information is in response to the at least one channel condition being satisfied for the second cell.

The first apparatus 110 may receive, from the third apparatus 530, configuration information including at least one channel condition for requesting the at least one TRS, an MCS threshold value, a CQI threshold value, a rank threshold, and/or the like.

During the cell switch procedure, the second apparatus 120 may transmit, to the third apparatus 530, configuration information. The configuration information may include at least one configured parameter for the at least one TRS, at least one channel condition for requesting the at least one TRS, an MCS threshold value, a CQI threshold value, a rank threshold, and/or the like. The third apparatus 530 may determine the configuration information to be transmitted to the first apparatus 110 based on the configuration information received from the second apparatus 120. In this way, the at least one channel condition and optionally the MSC, CQI or rank threshold may be configured based on configurations of the second apparatus 120.

Similar to those channel conditions described with respect to FIG. 4, the at least one channel condition here may include but not be limited to, an observed obtainable MCS being above or equal to the MCS threshold value, an obtainable CQI being above or equal to the CQI threshold value, or a rank being above or equal to the rank threshold.

In one example embodiment, the first apparatus 110 may (be configured to) indicate TRS request if it determines that it has measured (or determines that it will report) the channel conditions for the early CSI to be above or equal to the certain threshold value. The channel condition may refer to observed obtainable MCS, obtainable CQI, or rank.

In some example embodiments, the information may explicitly indicate the request for the at least one TRS. For example, the information may include an indication requesting the second apparatus 120 to provide the at least one TRS prior to or when scheduling downlink data, an indication that the at least one TRS is expected with a time interval after transmitting the indication information, or the like. The information may further indicate the time interval. The information may further indicate a type of the at least one TRS, such as aperiodic TRS or semi-persistent TRS. The information may include a CQI index, an MCS index, a rank value, and/or the like. The information may include at least one parameter for the at least one TRS, and/or an indication of a configuration of the at least one parameter for the at least one TRS.

With these embodiments, the first apparatus 110 such as UE may be configured or defined to send information related to TRS request to a cell after receiving a cell switch command triggering the cell switch to the cell. Such early TRS request may be used to obtain the TRS for subsequent channel estimation. It is to be understood that although in the illustrated example embodiments, the first cell and the second cell are associated with different apparatuses, in some example embodiments, the first and second cells are associated with a same apparatus such as a same gNB. That is, the cell switch may be an inter-gNB cell switch or intra-gNB cell switch.

With these embodiments described with respect to FIG. 3 to FIG. 5, the TRS transmission may be triggered by UE. The energy efficiency can be improved due to non-periodic transmission for reference signals. In addition, it provides more scheduling flexibility for network.

In some example embodiments of the present disclosure, an apparatus such as UE may determine whether at least one condition is satisfied. The at least one condition at least includes a first condition that a block error rate of a transmission via a physical shared channel is higher than a threshold value. If the at least one condition is satisfied, the apparatus may transmit an indication of a request for at least one TRS to a further apparatus. In this manner, the apparatus can request TRS based on block error rate. The network may transmit TRS when being requested. The energy efficiency can be improved due to non-periodic transmission for reference signals. In addition, it provides more scheduling flexibility for the network.

FIG. 6 illustrates another example signaling flow 600 for TRS request in accordance with some other example embodiments of the present disclosure. The signaling flow 600 involves the first apparatus 110 and the second apparatus 120 in FIG. 1.

In operation, the first apparatus 110 determines (6010) whether at least one condition is satisfied. The at least one condition at least includes a first condition that a block error rate (BLER) of a transmission via a physical shared channel such as PDSCH is higher than a threshold value. For example, the first condition may be that a first PDSCH transmission and/or a first hybrid automatic repeat request (HARQ) transmission is higher than a threshold value. The threshold value may be a predefined value, a value configured by the second apparatus 120, or a further block error rate of a previous transmission.

If the at least one condition is satisfied, the first apparatus 110 transmits (6020) an indication of a request for at least one TRS to the second apparatus 120. In response to receiving (6025) the indication of the TRS request, the second apparatus 120 transmits (6030) the at least one TRS to the first apparatus 110. Correspondingly, the first apparatus 110 may receive (6035) the at least one TRS.

In some example embodiments, the at least one condition further includes a second condition that a MCS value associated with the first apparatus 110 is greater than a threshold MCS value. The threshold MCS value may be an MCS index corresponds to a modulation higher than a threshold modulation, such as an MCS index corresponding to 64 QAM. The MCS value associated with the first apparatus 110 may be an MCS value used by the first apparatus 110. The threshold MCS value may be configured by the second apparatus 120.

In some examples, the first apparatus 110 keeps monitoring the selected MCS selected by gNB and BLER of the first transmission of PDSCH (i.e. the first HARQ transmission). If the used MCS is greater than certain MCS index (corresponds e.g. 64 QAM and higher modulation) and the first apparatus 110 determines that BLER of the first transmission goes higher, the first apparatus 110 may trigger TRS request.

In addition, the at least one condition may include one or more of those conditions described with respect to FIG. 3. For the purpose of discussion, details of these conditions will not be repeated here.

In some example embodiments, the indication of the request for the at least one TRS may indicate an MCS value used by the first apparatus 110, a threshold MCS value, or an indication that the MCS value is above the threshold MCS value.

In some example embodiments, the first apparatus 110 may be under intermediate channel conditions (with intermediate MCSs selected) and then channel conditions are improved gradually better and better. The first apparatus 110 may receive, from the second apparatus 120, a further MCS value higher than the MCS value used by the first apparatus 110 or higher than the threshold MCS value. At some point the second apparatus 120 may receive TRS request from the first apparatus 110. Upon providing the first apparatus 110 with TRS, the first apparatus 110 may be able to receive gradually increased higher MCSs and throughput may be improved correspondingly.

In some example embodiments, similar to the indication information described with respect to FIG. 3, the indication of the request may further indicate one or more of the following: an indication requesting the second apparatus 120 to provide the at least one TRS prior to or when scheduling downlink data, an indication that the at least one TRS is expected with a time interval after transmitting the indication information, the time interval, a type of the at least one TRS, a CQI index, a rank value, at least one parameter for the at least one TRS, an indication of a configuration of the at least one parameter for the at least one TRS, and/or the like. The type of the at least one TRS may include an aperiodic TRS, or a semi persistent TRS.

The indication of the request for the at least one TRS may be included in UCI, MAC CE, RRC message, a bitfield or an indication in a channel state information (CSI) report, or a further uplink signal. The further uplink signal may be associated with a random access procedure or a cell switch procedure. For example, the further uplink signal may be a RA preamble, Msg3, or the like.

In some example embodiments, if no TRS is received with a time window for receiving the at least one TRS, the first apparatus 110 may retransmit the indication of the request for the at least one TRS to the second apparatus 120, and/or limit at least one of a rank, an MCS, or a channel quality indicator to be reported to the second apparatus 120 to a predefined or configured value.

The first apparatus 110 may transmit, to the second apparatus 120, an indication for suspending of a usage of the at least one TRS from the second apparatus 120. For example, the first apparatus 110 may estimate the channel condition and decides to stop or suspend the usage of the at least one TRS.

It is to be understood that some conditions, features or options described with respect to FIG. 3 are also applicable to the signaling flow 600. For the purpose of simplification, the details thereof will not be repeated.

It would be appreciated that some example specifications, signaling flows and embodiments are provided above, and the detailed description may be varied. It is to be understood that these signaling flows 300, 400, 500 and/or 600 may be used separately, or in any suitable combinations. Some example embodiments, operations or features described with respect to one of these signaling flows 300, 400, 500 and/or 600 may be applied to another of these signaling flows. Part of one of these signaling flows 300, 400, 500 and/or 600 may be applied in combination with part of another signaling flow. It is to be understood that these signaling flows 300, 400, 500 and/or 600 may involve any other suitable operations or signaling not shown. With these signaling flows and similar signaling flows, the TRS based channel estimation can be enhanced.

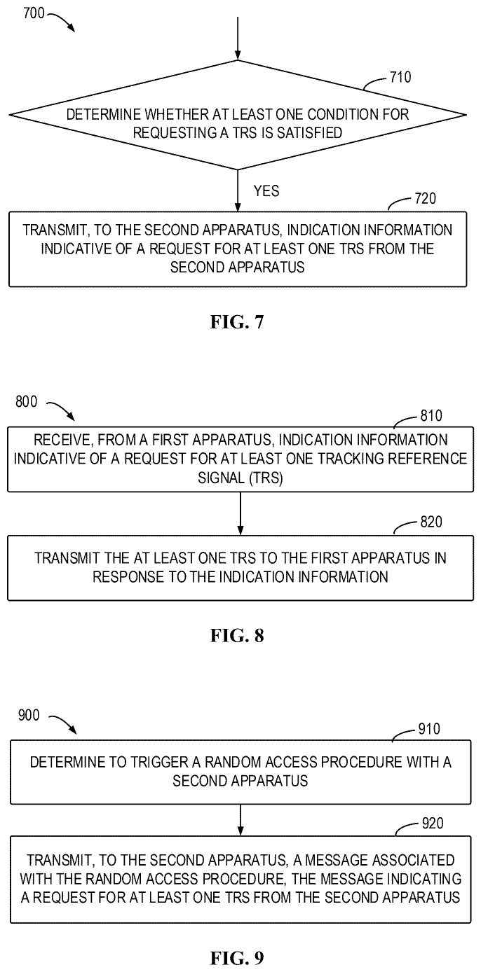

FIG. 7 shows a flowchart of an example method 700 implemented at a first apparatus in accordance with some example embodiments of the present disclosure. For the purpose of discussion, the method 700 will be described from the perspective of the first apparatus 110 in FIG. 1.

At block 710, the first apparatus 110 in FIG. 1 determines whether at least one condition for requesting a TRS is satisfied based on at least one of: a configuration from a second apparatus, data to be transmitted to the second apparatus, a BSR, an MCS associated with the first apparatus, or a rank associated with the first apparatus.

At block 720, in accordance with a determination that the at least one condition is satisfied, the first apparatus 110 in FIG. 1 transmits to the second apparatus, indication information indicative of a request for at least one TRS from the second apparatus.

In some example embodiments, the at least one condition comprises at least one of: that the data to be transmitted to the second apparatus arrives, that the first apparatus triggers a scheduling request of a BSR transmission, that no TRS being received within a time window for a previously requested TRS, that the first apparatus supports the rank based on channel measurement, that the first apparatus is unable to support at least one of the MCS or the rank without receiving a TRS, or that the first apparatus is unable to support at least one of the MCS or the rank with a current TRS with at least one parameter of the TRS, wherein the MCS and/or the rank being currently used by the first apparatus, or being indicated by the second apparatus, or being reported by the first apparatus.

In some example embodiments, the method 700 further comprises: receiving, from the second apparatus, configuration information comprising at least one of: the at least one condition, an indicated MCS, or an indicated rank.

In some example embodiments, the indication information indicates at least one of: an indication requesting the second apparatus to provide the at least one TRS prior to or when scheduling downlink data, an indication that the at least one TRS is expected with a time interval after transmitting the indication information, the time interval, a type of the at least one TRS, a CQI index, an MCS index, a rank value, at least one parameter for the at least one TRS, the at least one parameter comprising at least one of: a length of the at least one TRS, frequency allocation information for the at least one TRS, or a periodicity of the at least one TRS, or an indication of a configuration of the at least one parameter for the at least one TRS.

In some example embodiments, the type of the at least one TRS comprises one of: a aperiodic TRS, or a semi persistent TRS.

In some example embodiments, the at least one of the CQI index, MCS index, or rank value is above a corresponding threshold, and the corresponding threshold is configured by the second apparatus, or determined and indicated to the second apparatus by the first apparatus.

In some example embodiments, the method 700 further comprises: in accordance with a determination that no TRS is received with a time window for receiving the at least one TRS, performing at least one of: retransmitting the indication information to the second apparatus, or limiting at least one of a rank, an MCS, or a channel quality indicator to be reported to the second apparatus to a predefined or configured value.

In some example embodiments, the indication information is comprised in at least one of: UCI, MAC CE, RRC message, a bitfield or an indication in a CSI report, or a further uplink signal.

In some example embodiments, the further uplink signal is associated with a random access procedure or a cell switch procedure.

In some example embodiments, the method 700 further comprises: transmitting, to the second apparatus, an indication for suspending of a usage of the at least one TRS from the second apparatus.

In some example embodiments, a first apparatus capable of performing any of the method 700 (for example, the first apparatus 110 in FIG. 1) may comprise means for performing the respective operations of the method 700. The means may be implemented in any suitable form. For example, the means may be implemented in a circuitry or software module. The first apparatus may be implemented as or included in the first apparatus 110 in FIG. 1.

FIG. 8 shows a flowchart of an example method 800 implemented at a second apparatus in accordance with some example embodiments of the present disclosure. For the purpose of discussion, the method 800 will be described from the perspective of the second apparatus 120 in FIG. 1.

At block 810, the second apparatus 120 receives, from a first apparatus, indication information indicative of a request for at least one TRS.

At block 820, the second apparatus 120 transmits the at least one TRS to the first apparatus in response to the indication information.

In some example embodiments, the method 800 further comprises: transmitting, to the first apparatus, configuration information comprising at least one of: at least one condition for requesting the at least one TRS transmission, an indicated MCS, or an indicated rank.

In some example embodiments, the at least one condition comprises at least one of: that the data to be transmitted to the second apparatus arrives, that the first apparatus triggers a scheduling request of a BSR transmission, that no TRS being received within a time window for a previously requested TRS, that the first apparatus supports the rank based on channel measurement, that the first apparatus is unable to support at least one of the MCS or the rank without receiving a TRS, that the first apparatus is unable to support at least one of the MCS or the rank with a current TRS with at least one parameter of the TRS, wherein the MCS and/or the rank being currently used by the first apparatus, or being indicated by the second apparatus, or being reported by the first apparatus.

In some example embodiments, the indication information indicates at least one of: an indication requesting the second apparatus to provide the at least one TRS prior to or when scheduling downlink data, an indication that the at least one TRS is expected with a time interval after transmitting the indication information, the time interval, a type of the at least one TRS, a CQI index, an MCS index, a rank value, at least one parameter for the at least one TRS, the at least one parameter comprising at least one of: a length of the at least one TRS, frequency allocation information for the at least one TRS, or a periodicity of the at least one TRS, or an indication of a configuration of the at least one parameter for the at least one TRS.

In some example embodiments, the method 800 further comprises: receiving, from the first apparatus, an indication for suspending of a usage of the at least one TRS from the second apparatus.

In some example embodiments, the first apparatus comprises a terminal device, and the second apparatus comprises a network device.

In some example embodiments, a second apparatus capable of performing any of the method 800 (for example, the second apparatus 120 in FIG. 1) may comprise means for performing the respective operations of the method 800. The means may be implemented in any suitable form. For example, the means may be implemented in a circuitry or software module. The second apparatus may be implemented as or included in the second apparatus 120 in FIG. 1.

FIG. 9 shows a flowchart of an example method 900 implemented at a first apparatus in accordance with some example embodiments of the present disclosure. For the purpose of discussion, the method 900 will be described from the perspective of the first apparatus 110 in FIG. 1.

At block 910, the first apparatus 110 determines to trigger a random access procedure with a second apparatus.

At block 920, the first apparatus 110 transmits, to the second apparatus, a message associated with the random access procedure, the message indicating a request for at least one TRS from the second apparatus.

In some example embodiments, the message associated with the random access procedure comprises at least one of: a random access preamble, or a message 3 (Msg3) for the random access procedure, or a message multiplexed with the Msg3.

In some example embodiments, the method 900 further comprises: determining whether at least one channel condition for requesting the at least one TRS is satisfied; and wherein the transmitting of the request is in response to the at least one channel condition being satisfied.

In some example embodiments, the method 900 further comprises: receiving, from the second apparatus, configuration information comprising at least one of: at least one channel condition for indicating the request for the at least one TRS in the message associated with the random access procedure, an MCS threshold value, a CQI threshold value, or a rank threshold.

In some example embodiments, the at least one channel condition comprises at least one of: an MCS is above or equal to the MCS threshold value, a CQI is above or equal to the CQI threshold value, or a rank is above or equal to the rank threshold.

In some example embodiments, the at least one channel condition is determined based on at least one measured channel state information reference signal scheduled by the second apparatus or indicated in system information.

In some example embodiments, the random access procedure comprises a contention based random access or a contention free random access.

In some example embodiments, the message associated with the random access procedure indicates at least one of: an indication requesting the second apparatus to provide the at least one TRS prior to or when scheduling downlink data, an indication that the at least one TRS is expected with a time interval after transmitting the indication information, the time interval, a type of the at least one TRS, a CQI index, an MCS index, a rank value, at least one parameter for the at least one TRS, the at least one parameter comprising at least one of: a length of the at least one TRS, frequency allocation information for the at least one TRS, or a periodicity of the at least one TRS, or an indication of a configuration of the at least one parameter for the at least one TRS.

In some example embodiments, the first apparatus comprises a terminal device, and the second apparatus comprises a network device.

In some example embodiments, a first apparatus capable of performing any of the method 900 (for example, the first apparatus 110 in FIG. 1) may comprise means for performing the respective operations of the method 900. The means may be implemented in any suitable form. For example, the means may be implemented in a circuitry or software module. The first apparatus may be implemented as or included in the first apparatus 110 in FIG. 1.

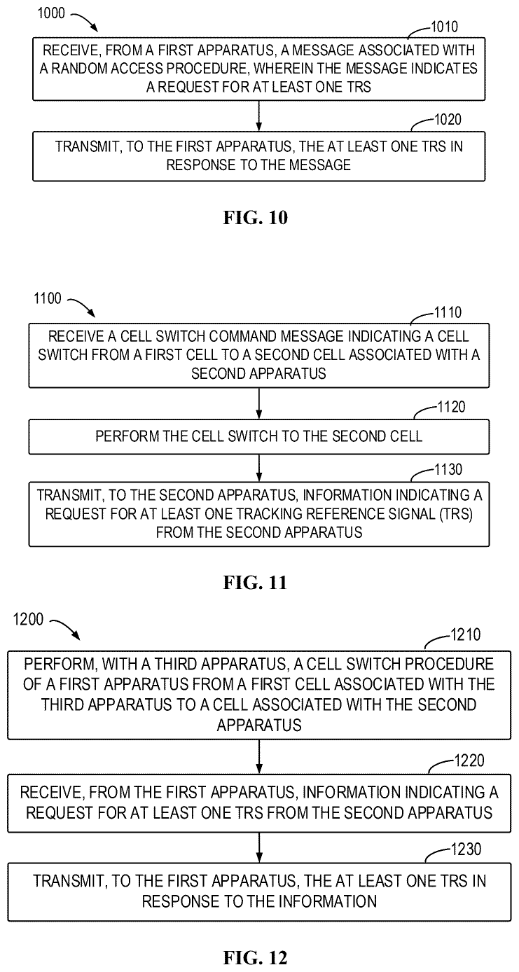

FIG. 10 shows a flowchart of an example method 1000 implemented at a second apparatus in accordance with some example embodiments of the present disclosure. For the purpose of discussion, the method 1000 will be described from the perspective of the second apparatus 120 in FIG. 1.

At block 1010, the second apparatus 120 receives, from a first apparatus, a message associated with a random access procedure, where the message indicates a request for at least one TRS.

At block 1020, the second apparatus 120 transmits, to the first apparatus, the at least one TRS in response to the message.

In some example embodiments, the message associated with the random access procedure comprises at least one of: a random access preamble, or a message 3 (Msg3) for the random access procedure, or a message multiplexed with the Msg3.

In some example embodiments, the random access procedure comprises a contention based random access or a contention free random access.

In some example embodiments, the method 1000 further comprises: transmitting, to the first apparatus, configuration information comprising at least one of: at least one channel condition for indicating the request for the at least one TRS in the message associated with the random access procedure, a MCS threshold value, a channel quality indicator (CQI) threshold value, or a rank threshold.

In some example embodiments, the at least one channel condition comprises at least one of: an MCS is above or equal to the MCS threshold value, a CQI is above or equal to the CQI threshold value, or a rank is above or equal to the rank threshold.

In some example embodiments, the message associated with the random access procedure indicates at least one of: an indication requesting the second apparatus to provide the at least one TRS prior to or when scheduling downlink data, an indication that the at least one TRS is expected with a time interval after transmitting the indication information, the time interval, a type of the at least one TRS, a CQI index, an MCS index, a rank value, at least one parameter for the at least one TRS, the at least one parameter comprising at least one of: a length of the at least one TRS, frequency allocation information for the at least one TRS, or a periodicity of the at least one TRS, or an indication of a configuration of the at least one parameter for the at least one TRS.

In some example embodiments, the first apparatus comprises a terminal device, and the second apparatus comprises a network device.

In some example embodiments, a second apparatus capable of performing any of the method 1000 (for example, the second apparatus 120 in FIG. 1) may comprise means for performing the respective operations of the method 1000. The means may be implemented in any suitable form. For example, the means may be implemented in a circuitry or software module. The second apparatus may be implemented as or included in the second apparatus 120 in FIG. 1.

FIG. 11 shows a flowchart of an example method 1100 implemented at a first apparatus in accordance with some example embodiments of the present disclosure. For the purpose of discussion, the method 1100 will be described from the perspective of the first apparatus 110 in FIG. 1.

At block 1110, the first apparatus 110 in FIG. 1 receives a cell switch command message indicating a cell switch from a first cell to a second cell associated with a second apparatus.

At block 1120, the first apparatus 110 in FIG. 1 performs the cell switch to the second cell.

At block 1130, the first apparatus 110 in FIG. 1 transmits, to the second apparatus, information indicating a request for at least one TRS from the second apparatus.

In some example embodiments, the information indicating the request is transmitted via an uplink channel associated with a grant for a random access channel-less cell switch.

In some example embodiments, the grant comprises at least one of: a configured grant for the cell switch, or a dynamic grant for the cell switch.

In some example embodiments, the information indicating the request is transmitted via an uplink channel associated with at least one of: a dynamic grant for a message in a random access channel based cell switch, or a dynamic grant for an uplink transmission after a random access channel procedure.

In some example embodiments, the cell switch command message indicates at least one of: a requirement of the request for the at least one TRS, or at least one configured parameter for the at least one TRS.

In some example embodiments, the method 1100 further comprises: determining whether at least one channel condition for requesting the at least one TRS is satisfied for the second cell based on measurements of the second cell performed before the cell switch; and wherein the transmitting of the information is in response to the at least one channel condition being satisfied for the second cell.

In some example embodiments, the method 1100 further comprises: receiving, from a third apparatus associated with the first cell, configuration information comprising at least one of: at least one channel condition for requesting the at least one TRS, an MCS threshold value, a CQI threshold value, or a rank threshold.

In some example embodiments, the at least one channel condition comprises at least one of: an observed obtainable MCS is above or equal to the MCS threshold value, an obtainable CQI is above or equal to the CQI threshold value, or a rank is above or equal to the rank threshold.

In some example embodiments, the information indicating the request for the at least one TRS indicates one of: an indication requesting the second apparatus to provide the at least one TRS prior to or when scheduling downlink data, an indication that the at least one TRS is expected with a time interval after transmitting the indication information, the time interval, a type of the at least one TRS, a CQI index, an MCS index, a rank value, at least one parameter for the at least one TRS, the at least one parameter comprising at least one of: a length of the at least one TRS, frequency allocation information for the at least one TRS, or a periodicity of the at least one TRS, or an indication of a configuration of the at least one parameter for the at least one TRS.

In some example embodiments, the information is comprised in at least one of: UCI, MAC CE, or RRC message.

In some example embodiments, a first apparatus capable of performing any of the method 1100 (for example, the first apparatus 110 in FIG. 1) may comprise means for performing the respective operations of the method 1100. The means may be implemented in any suitable form. For example, the means may be implemented in a circuitry or software module. The first apparatus may be implemented as or included in the first apparatus 110 in FIG. 1.

FIG. 12 shows a flowchart of an example method 1200 implemented at a second apparatus in accordance with some example embodiments of the present disclosure. For the purpose of discussion, the method 1200 will be described from the perspective of the second apparatus 120 in FIG. 1.

At block 1210, the second apparatus 120 performs, with a third apparatus, a cell switch procedure of a first apparatus from a first cell associated with the third apparatus to a cell associated with the second apparatus.

At block 1220, the second apparatus 120 receives, from the first apparatus, information indicating a request for at least one TRS from the second apparatus.

At block 1230, the second apparatus 120 transmits, to the first apparatus, the at least one TRS in response to the information.

In some example embodiments, the performing the cell switch procedure comprises: transmitting to the third apparatus, configuration information comprising at least one of: at least one configured parameter for the at least one TRS, at least one channel condition for requesting the at least one TRS, an MCS threshold value, a CQI threshold value, or a rank threshold.

In some example embodiments, the at least one channel condition comprises at least one of: an observed obtainable MCS is above or equal to the MCS threshold value, an obtainable CQI is above or equal to the CQI threshold value, or a rank is above or equal to the rank threshold.

In some example embodiments, the information indicating the request for the at least one TRS indicates one of: an indication requesting the second apparatus to provide the at least one TRS prior to or when scheduling downlink data, an indication that the at least one TRS is expected with a time interval after transmitting the indication information, the time interval, a type of the at least one TRS, a CQI index, an MCS index, a rank value, at least one parameter for the at least one TRS, the at least one parameter comprising at least one of: a length of the at least one TRS, frequency allocation information for the at least one TRS, or a periodicity of the at least one TRS, or an indication of a configuration of the at least one parameter for the at least one TRS.

In some example embodiments, the first apparatus comprises a terminal device, and the second apparatus comprises a network device.

In some example embodiments, a second apparatus capable of performing any of the method 1200 (for example, the second apparatus 120 in FIG. 1) may comprise means for performing the respective operations of the method 1200. The means may be implemented in any suitable form. For example, the means may be implemented in a circuitry or software module. The second apparatus may be implemented as or included in the second apparatus 120 in FIG. 1.

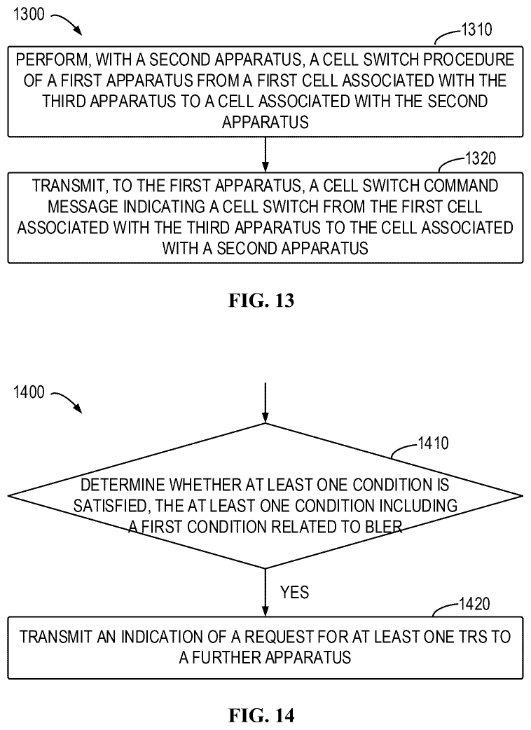

FIG. 13 shows a flowchart of an example method 1300 implemented at a third apparatus in accordance with some example embodiments of the present disclosure. For the purpose of discussion, the method 1300 will be described from the perspective of the third apparatus 530 in FIG. 5.

At block 1310, the third apparatus 530 performs, with a second apparatus, a cell switch procedure of a first apparatus from a first cell associated with the third apparatus 530 to a cell associated with the second apparatus.

At block 1320, the third apparatus 530 transmits, to the first apparatus, a cell switch command message indicating a cell switch from the first cell associated with the third apparatus to the cell associated with a second apparatus. The cell switch command message indicates at least one of: a requirement of a request for at least one TRS from the second apparatus, or at least one configured parameter for the at least one TRS.

In some example embodiments, the performing the cell switch procedure comprises: receiving, from the second apparatus, configuration information comprising at least one of: the at least one configured parameter for the at least one TRS, at least one channel condition for requesting the at least one TRS, an MCS threshold value, a CQI threshold value, or a rank threshold.

In some example embodiments, the at least one channel condition comprises at least one of: an observed obtainable MCS is above or equal to the MCS threshold value, an obtainable CQI is above or equal to the CQI threshold value, or a rank is above or equal to the rank threshold.

In some example embodiments, the first apparatus comprises a terminal device, and the second apparatus comprises a first network device, and the third apparatus comprises a second network device.

In some example embodiments, a third apparatus capable of performing any of the method 1300 (for example, the third apparatus 530 in FIG. 5) may comprise means for performing the respective operations of the method 1300. The means may be implemented in any suitable form. For example, the means may be implemented in a circuitry or software module. The third apparatus may be implemented as or included in the third apparatus 530 in FIG. 5.

FIG. 14 shows a flowchart of an example method 1400 implemented at an apparatus in accordance with some example embodiments of the present disclosure. For the purpose of discussion, the method 1400 will be described from the perspective of first the first apparatus 110 in FIG. 1.

At block 1410, the first apparatus 110 determines whether at least one condition is satisfied. The at least one condition at least includes a first condition that a block error rate of a transmission via a physical shared channel is higher than a threshold value.

At block 1420, in accordance with a determination that the at least one condition is satisfied, the first apparatus 110 transmits an indication of a request for at least one TRS to a further apparatus.

In some example embodiments, the transmission via the physical shared channel comprises a first physical downlink shared channel transmission.

In some example embodiments, the transmission via the physical shared channel comprises a first hybrid automatic repeat request (HARQ) transmission.

In some example embodiments, the threshold value comprises one of: a predefined value, a value configured by the further apparatus, or a further block error rate of a previous transmission.

In some example embodiments, the at least one condition further comprises a second condition that an MCS value associated with the first apparatus 110 is greater than a threshold MCS value.

In some example embodiments, the threshold MCS value comprises an MCS index corresponds to a modulation higher than a threshold modulation.

In some example embodiments, the MCS value associated with the apparatus comprises an MCS value used by the first apparatus 110.

In some example embodiments, the threshold MCS value is configured by the further apparatus.

In some example embodiments, the at least one condition further comprises at least one of: that data to be transmitted to the further apparatus arrives, that the first apparatus 110 triggers a scheduling request of a buffer status report transmission, that no TRS being received within a time window for a previously requested TRS, that the first apparatus 110 supports a rank associated with the first apparatus 110 based on channel measurement, that the first apparatus 110 is unable to support at least one of an MCS or a rank associated with the first apparatus 110 without receiving a TRS, that the first apparatus 110 is unable to support at least one of the MCS or the rank with a current TRS with at least one parameter of the TRS, where the MCS and/or the rank being currently used by the first apparatus 110, or being indicated by the second apparatus, or being reported by the first apparatus 110.

In some example embodiments, the indication of the request for the at least one TRS indicates at least one of: an MCS value used by the first apparatus 110, a threshold MCS value, or an indication that the MCS value is above the threshold MCS value.

In some example embodiments, the method 1400 further comprises: receiving, from the further apparatus, the at least one TRS; and receiving, from the further apparatus, a further MCS value higher than the MCS value used by the first apparatus 110 or higher than the threshold MCS value.

In some example embodiments, the indication of the request further indicates at least one of: an indication requesting the further apparatus to provide the at least one TRS prior to or when scheduling downlink data, an indication that the at least one TRS is expected with a time interval after transmitting the indication information, the time interval, a type of the at least one TRS, a CQI index, a rank value, at least one parameter for the at least one TRS, the at least one parameter comprising at least one of: a length of the at least one TRS, frequency allocation information for the at least one TRS, or a periodicity of the at least one TRS, or an indication of a configuration of the at least one parameter for the at least one TRS.

In some example embodiments, the type of the at least one TRS comprises one of: a aperiodic TRS, or a semi persistent TRS.

In some example embodiments, the indication of the request for the at least one TRS is comprised in at least one of: UCI, a MAC CE, an RRC message, a bitfield or an indication in a CSI report, or a further uplink signal.

In some example embodiments, the further uplink signal is associated with a random access procedure or a cell switch procedure.

In some example embodiments, the method 1400 further comprises: in accordance with a determination that no TRS is received with a time window for receiving the at least one TRS, performing at least one of: retransmitting the indication of the request for the at least one TRS to the further apparatus, or limiting at least one of a rank, an MCS, or a channel quality indicator to be reported to the further apparatus to a predefined or configured value.

In some example embodiments, the method 1400 further comprises: transmitting, to the further apparatus, an indication for suspending of a usage of the at least one TRS from the further apparatus.

In some example embodiments, the first apparatus 110 is a UE or comprised in a UE, and the further apparatus comprises a network device.

In some example embodiments, an apparatus capable of performing any of the method 1400 (for example, the first apparatus 110 in FIG. 1) may comprise means for performing the respective operations of the method 1400. The means may be implemented in any suitable form. For example, the means may be implemented in a circuitry or software module. The apparatus may be implemented as or included in the first apparatus 110 in FIG. 1.

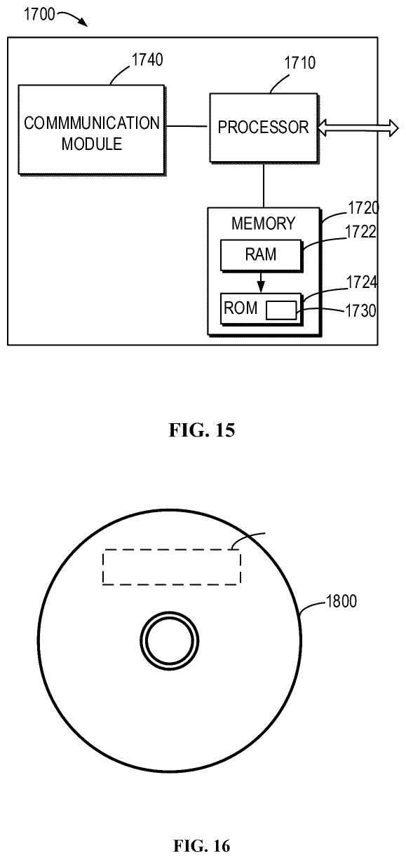

FIG. 15 is a simplified block diagram of a device 1700 that is suitable for implementing example embodiments of the present disclosure. The device 1700 may be provided to implement a communication device, for example, the first apparatus 110 or the second apparatus 120 as shown in FIG. 1. As shown, the device 1700 includes one or more processors 1710, one or more memories 1720 coupled to the processor 1710, and one or more communication modules 1740 coupled to the processor 1710.

The communication module 1740 is for bidirectional communications. The communication module 1740 has one or more communication interfaces to facilitate communication with one or more other modules or devices. The communication interfaces may represent any interface that is necessary for communication with other network elements. In some example embodiments, the communication module 1740 may include at least one antenna.

The processor 1710 may be of any type suitable to the local technical network and may include one or more of the following: general purpose computers, special purpose computers, microprocessors, digital signal processors (DSPs) and processors based on multicore processor architecture, as non-limiting examples. The device 1700 may have multiple processors, such as an application specific integrated circuit chip that is slaved in time to a clock which synchronizes the main processor.

The memory 1720 may include one or more non-volatile memories and one or more volatile memories. Examples of the non-volatile memories include, but are not limited to, a Read Only Memory (ROM) 1724, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random-access memory (RAM) 1722 and other volatile memories that will not last in the power-down duration.

A computer program 1730 includes computer executable instructions that are executed by the associated processor 1710. The instructions of the program 1730 may include instructions for performing operations/acts of some example embodiments of the present disclosure. The program 1730 may be stored in the memory, e.g., the ROM 1724. The processor 1710 may perform any suitable actions and processing by loading the program 1730 into the RAM 1722.

The example embodiments of the present disclosure may be implemented by means of the program 1730 so that the device 1700 may perform any process of the disclosure as discussed with reference to FIG. 3 to FIG. 14. The example embodiments of the present disclosure may also be implemented by hardware or by a combination of software and hardware.

In some example embodiments, the program 1730 may be tangibly contained in a computer readable medium which may be included in the device 1700 (such as in the memory 1720) or other storage devices that are accessible by the device 1700. The device 1700 may load the program 1730 from the computer readable medium to the RAM 1722 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 16 shows an example of the computer readable medium 1800 which may be in form of CD, DVD or other optical storage disk. The computer readable medium 1800 has the program 1730 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general-purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. An apparatus comprising:
at least one processor; and
at least one memory storing instructions that, when executed by the at least one processor, cause the apparatus to:
determine whether at least one condition is satisfied, the at least one condition at least comprising a first condition that a block error rate of a transmission via a physical shared channel is higher than a threshold value; and
in accordance with a determination that the at least one condition is satisfied, transmit an indication of a request for at least one tracking reference signal (TRS) to a further apparatus.

2. The apparatus of claim 1, wherein the transmission via the physical shared channel comprises a first physical downlink shared channel transmission.

3. The apparatus of claim 1, wherein the transmission via the physical shared channel comprises a first hybrid automatic repeat request (HARQ) transmission.

4. The apparatus of claim 1, wherein the threshold value comprises one of: a predefined value, a value configured by the further apparatus, or a further block error rate of a previous transmission.

5. The apparatus of claim 1, wherein the at least one condition further comprises a second condition that a modulation and coding scheme (MCS) value associated with the apparatus is greater than a threshold MCS value.

6. The apparatus of claim 5, wherein the threshold MCS value comprises an MCS index corresponds to a modulation higher than a threshold modulation.

7. The apparatus of claim 5, wherein the MCS value associated with the apparatus comprises an MCS value used by the apparatus.

8. The apparatus of claim 5, wherein the threshold MCS value is configured by the further apparatus.

9. The apparatus of claim 1, wherein the at least one condition further comprises at least one of:
that data to be transmitted to the further apparatus arrives,
that the apparatus triggers a scheduling request of a buffer status report transmission,
that no TRS being received within a time window for a previously requested TRS,
that the apparatus supports a rank associated with the apparatus based on channel measurement,
that the apparatus is unable to support at least one of a modulation and coding scheme (MCS) or a rank associated with the apparatus without receiving a TRS, or
that the apparatus is unable to support at least one of the MCS or the rank with a current TRS with at least one parameter of the TRS,
wherein the MCS and/or the rank being currently used by the apparatus, or being indicated by the further apparatus, or being reported by the apparatus.

10. The apparatus of claim 1, wherein the indication of the request for the at least one TRS indicates at least one of:
a modulation and coding scheme (MCS) value used by the apparatus,
a threshold MCS value, or
an indication that the MCS value is above the threshold MCS value.

11. The apparatus of claim 10, wherein the apparatus is further caused to:
receive, from the further apparatus, the at least one TRS; and
receive, from the further apparatus, a further MCS value higher than the MCS value used by the apparatus or higher than the threshold MCS value.

12. The apparatus of claim 1, wherein the indication of the request further indicates at least one of:
an indication requesting the further apparatus to provide the at least one TRS prior to or when scheduling downlink data,
an indication that the at least one TRS is expected with a time interval after transmitting the indication information,
the time interval,
a type of the at least one TRS,
a channel quality indicator (CQI) index,
a rank value,
at least one parameter for the at least one TRS, the at least one parameter comprising at least one of: a length of the at least one TRS, frequency allocation information for the at least one TRS, or a periodicity of the at least one TRS, or
an indication of a configuration of the at least one parameter for the at least one TRS.

13. The apparatus of claim 12, wherein the type of the at least one TRS comprises one of: an aperiodic TRS, or a semi persistent TRS.

14. The apparatus of claim 1, wherein the indication of the request for the at least one TRS is comprised in at least one of:
uplink control information (UCI),
a medium access control control element (MAC CE),
a radio resource control (RRC) message,
a bitfield or an indication in a channel state information (CSI) report, or
a further uplink signal.

15. The apparatus of claim 14, wherein the further uplink signal is associated with a random access procedure or a cell switch procedure.

16. The apparatus of claim 1, wherein the apparatus is further caused to:
in accordance with a determination that no TRS is received with a time window for receiving the at least one TRS, perform at least one of:
retransmitting the indication of the request for the at least one TRS to the further apparatus, or
limiting at least one of a rank, an MCS, or a channel quality indicator to be reported to the further apparatus to a predefined or configured value.

17. The apparatus of claim 1, wherein the apparatus is further caused to:
transmit, to the further apparatus, an indication for suspending of a usage of the at least one TRS from the further apparatus.

18. The apparatus of claim 1, wherein the apparatus is a User Equipment, UE, or wherein the apparatus is comprised in a UE, and the further apparatus comprises a network device.

19. A method comprising:
determining, at an apparatus, whether at least one condition is satisfied, the at least one condition at least comprising a first condition that a block error rate of a transmission via a physical shared channel is higher than a threshold value; and
in accordance with a determination that the at least one condition is satisfied, transmitting an indication of a request for at least one tracking reference signal (TRS) to a further apparatus.

20. A non-transitory computer readable medium comprising instructions stored thereon for causing an apparatus at least to:
determine whether at least one condition is satisfied, the at least one condition at least comprising a first condition that a block error rate of a transmission via a physical shared channel is higher than a threshold value; and
in accordance with a determination that the at least one condition is satisfied, transmit an indication of a request for at least one tracking reference signal (TRS) to a further apparatus.
